(19) United States
(12) Patent Application Publication
(10) Pub. No.: US 2008/0066726 A1
(43) Pub. Date: Mar. 20, 2008

(54) Ceramic engine cylinder assembly of a car

(76) Inventor: Jin-Shing Dai, Tainan City (TW)

Correspondence Address: PRO-TECHTOR INTERNATIONAL SERVICES, 20775 NORADA CT., SARATOGA, CA, 95070, US

(21) Appl. No.: 11/521,799

(22) Filed: Sep. 15, 2006

(51) Int. Cl. F02B 75/08; F02F 1/00; F02F 3/00

(52) U.S. Cl. 123/668; 123/193.6; 123/193.2

(57) ABSTRACT

A ceramic engine cylinder assembly of a car comprises a cylinder and a piston. A layer of ceramic material is coated on an inner surface of the cylinder; similarly, a layer of ceramic material is coated on an outer surface of the piston. When the piston is moving in the inner surface of the cylinder reciprocately, which can produce better lubricating effects so as to reduce the friction resistance and increase the power of the engine.

### BACKGROUND OF THE INVENTION

1. Field of the Invention

The present invention relates to an engine cylinder assembly of a car, and more particularly to a ceramic engine cylinder assembly of a car which can reduce the friction coefficient.

2. Description of the Prior Art

In order to provide the lubricating effects when a piston of a conventional engine cylinder assembly of a car is moved reciprocately, the lubricating oil is added to the fuel, thereby part of the fuel molecules are surrounded by the lubricating oil before the fuel is combusted, and the fuel surrounded by the lubricating oil cannot be combusted completely, which will cause the problems of contaminating the environment and wasting fuel.

By adding the lubricating oil to the fuel, since the outer surface of the piston abuts against the inner surface of the cylinder when the piston is moving in the cylinder reciprocately, the lubricating effects is not good, on the contrary, the friction resistance is increased, and the power of the engine is reduced.

The present invention has arisen to mitigate and/or obviate the afore-described disadvantages.

### SUMMARY OF THE INVENTION

The primary objective of the present invention is to provide a ceramic engine cylinder assembly of a car comprises a cylinder and a piston. A layer of ceramic material is coated on an inner surface of the cylinder; similarly, a layer of ceramic material is coated on an outer surface of the piston. Since the ceramic material has the properties of heat-resisting and wear-resisting, when the piston is moving in the inner surface of the cylinder reciprocately, which can produce better lubricating effects so as to reduce the friction resistance, increase the power of the engine, and prolong the life of the piston.

The layer of ceramic material is coated on an inner surface of the cylinder by means of electroplating.

Similarly, the layer of ceramic material is coated on an outer surface of the piston by means of electroplating.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a assembly and operation plan view of a ceramic engine cylinder assembly of a car in accordance with the present invention; and

FIG. 2 is a perspective view of a piston of the ceramic engine cylinder assembly of a car in accordance with the present invention.

### DETAILED DESCRIPTION OF THE PREFERRED EMBODIMENTS

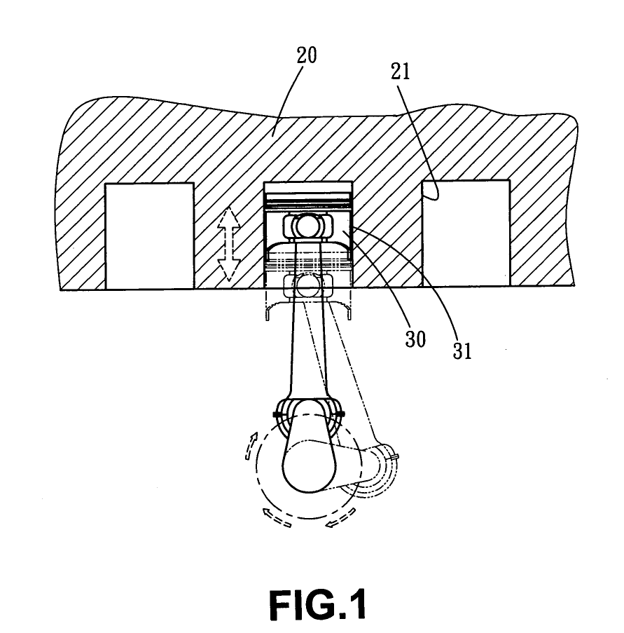

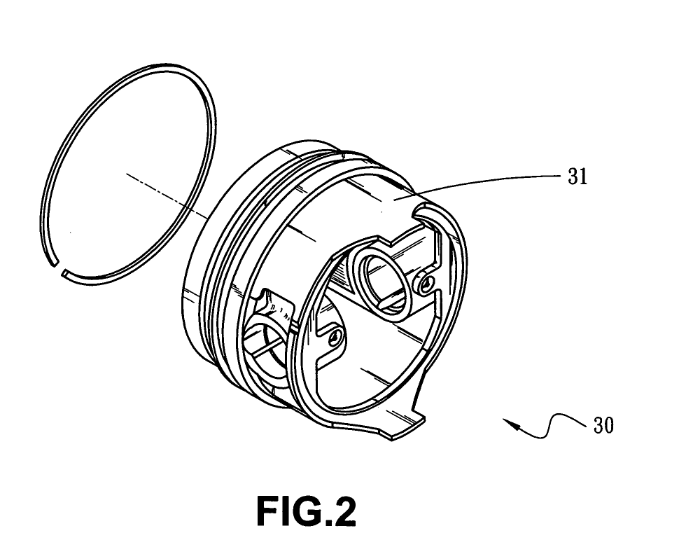

Referring to FIGS. 1 and 2, a ceramic engine cylinder assembly of a car in accordance with the present invention comprises a cylinder 20 and a piston 30. A layer of ceramic material 21 is coated on an inner surface of the cylinder 20 by electroplating; similarly, a layer of ceramic material 31 is coated on an outer surface of the piston 30 by means of electroplating.

Since the ceramic materials 31 and 21 have a better hardness, and have the wear-resisting and high temperature resisting properties, when the piston 30 moves in the cylinder 20 reciprocately, the outer surface of the piston 30 and the inner surface of the cylinder 20 coated with the ceramic materials 31 and 21 also have the properties of heat-resisting and wear-resisting. Therefore, when the piston 30 moves against the inner surface of the cylinder 20 reciprocately, the lubricating effects can be improved, the friction resistance can be reduced and the power of the engine can be increased.

Since the lubricating effects is improved and the power of the engine is increased when the piston 30 moves in the inner surface of the cylinder 20 reciprocately, the fuel consumption can be reduced effectively, and the fuel can be combusted completely, which has the function of environmental protection, and the life of the piston 30 is prolonged.

It is to be noted that the above-mentioned ceramic materials 21 and 31 are not restricted to being coated on the inner surface of the cylinder 20 and the outer surface of the piston 30 simultaneously, the ceramic material 21 can also be coated on the inner surface of the cylinder 20 only, or the ceramic material 31 can also be only coated on the outer surface of the piston 30.

While we have shown and described various embodiments in accordance with the present invention, it should be clear to those skilled in the art that further embodiments may be made without departing from the scope of the present invention.

What is claimed is:

1. A ceramic engine cylinder assembly of a car, comprising:
a cylinder coated with a layer of ceramic material on an inner surface thereof by means of electroplating; and
a piston coated with a layer of ceramic material on an outer surface thereof by means of electroplating, thus producing better lubricating effects when the piston moves in the cylinder reciprocately.

2. A ceramic engine cylinder assembly of a car, comprising:
a cylinder coated with a layer of ceramic material on an inner surface thereof by means of electroplating; and
a piston, which produces better lubricating effects when the piston moves in the inner surface of the cylinder reciprocately.

3. A ceramic engine cylinder assembly of a car, comprising:
a cylinder having an inner surface; and
a piston coated with a layer of ceramic material on an outer surface thereof by means of electroplating, thus producing better lubricating effects when the piston moves in the inner surface of the cylinder reciprocately.
